(19) United States
(12) Patent Application Publication
(10) Pub. No.: US 2020/0091629 A1
(43) Pub. Date: Mar. 19, 2020

(54) ELECTRICAL CONNECTORS FOR COAXIAL TRANSMISSION LINES INCLUDING TAPER AND ELECTRICALLY THIN RESISTIVE LAYER

(71) Applicant: Keysight Technologies, Inc., Minneapolis, MN (US)

(72) Inventors: Lewis R. Dove, Monument, CO (US); Gregory S. Lee, Mountain View, CA (US)

(21) Appl. No.: 15/749,777

(22) PCT Filed: Jun. 27, 2016
(86) PCT No.: PCT/US2016/039593

§ 371 Date: Feb. 1, 2018

Related U.S. Application Data
(63) Continuation-in-part of application No. 14/823,997, filed on Aug. 11, 2015, now Pat. No. 10,109,904.

(51) Int. Cl. H01R 9/05; H01P 1/162; H01P 3/06; H01P 5/02; H01R 24/40

(52) U.S. Cl. CPC H01R 9/0503; H01P 1/162; H01R 2201/24; H01P 5/026; H01R 24/40; H01P 3/06

(57) ABSTRACT

An electrical connector configured to electrically couple a signal transmission line to another signal transmission line is disclosed. The electrical connector comprises: a first electrical conductor disposed around a center axis, the first electrical conductor having a taper along its length, wherein the first electrical conductor is substantially azimuthally symmetric around the center axis; a second electrical conductor disposed around the center axis, the second electrical conductor having the taper along its length, the second electrical conductor being substantially azimuthally symmetric around the center axis; a dielectric region comprising a gas, and disposed between the first electrical conductor and the second electrical conductor, the dielectric region having the taper along its length; and a dielectric element disposed in the dielectric region between the first and second electrical conductors, the dielectric element being substantially azimuthally symmetric around the center axis.

### CROSS REFERENCE TO RELATED APPLICATIONS

This application is a continuation-in-part under 37 C.F.R. § 1.53(b) of commonly owned U.S. patent application Ser. No. 15/008,368 to Dove, et al., filed Jan. 27, 2016 and entitled “Signal Transmission Line and Electrical Connector including Electrically Thin Resistive Layer and Associated Methods.” U.S. patent application Ser. No. 15/008,368 to Dove, et al. is a continuation in part under 37 C.F.R 1.53(b) of commonly owned U.S. patent application Ser. No. 14/823,997 to Dove, et al. entitled “Coaxial Transmission Line Including Electrically Thin Resistive Layer and Associated Methods” filed on Aug. 11, 2015. The present application claims priority under 35 U.S.C. § 120 to. U.S. patent application Ser. No 15/008,368 and to U.S. patent application Ser. No. 14/823,997, the disclosures of which are hereby incorporated by reference in their entireties.

### BACKGROUND

Signal transmission lines (‘transmission lines’) are ubiquitous in modern communications. These transmission lines transmit electromagnetic (EM) signals (‘signals’) from point to point, and take on various known forms including stripline, microstripline (‘microstrip’), and coaxial (“coax”) transmission lines, to name a few.

It is desirable for these transmission lines to propagate a single eigenmode (‘single mode’) of signal propagation. Multi-mode signal propagation is problematic because the desired propagation mode and higher-order modes may interfere with each other to provide a received signal that is severely frequency-dependent in an uncontrolled and usually un-interpretable manner. This is analogous to the well-known multipath problem in wireless propagation, except in this instance the problem occurs in a “wired” setting. In high-bandwidth, high-quality signal environments multi-mode signal propagation is typically unacceptable.

What is needed, therefore, is a transmission line that fosters discrimination of a desired TEM mode of signal propagation from the higher-order modes.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a cross-sectional view of a coaxial transmission line in accordance with a representative embodiment.

FIG. 2 is a cross-sectional view of the representative embodiment of FIG. 1 and illustrates the TEM mode electric field.

FIG. 3 is a perspective view of the representative embodiment of FIG. 1.

FIG. 4 is a cross-sectional view of a coaxial transmission line in accordance with a representative embodiment.

FIG. 5 is a side view of a coaxial transmission line in accordance with a representative embodiment.

FIGS. 6 and 7 are tables illustrating mode cutoff eigenvalues of higher order modes, for a 50-ohm coaxial cable, that may/may not be attenuated in the representative embodiments.

FIG. 8 is a cross-sectional view of a transmission line in accordance with a representative embodiment.

FIG. 9 is a cross-sectional view of a microstripline (microstrip) transmission line in accordance with a representative embodiment.

FIG. 10 is a cross-sectional view of a microstrip transmission line in accordance with a representative embodiment.

FIG. 11 is a cross-sectional view of a stripline transmission line in accordance with a representative embodiment.

FIG. 12 is a cross-sectional view of a stripline transmission line in accordance with a representative embodiment.

FIG. 13A is a cross-sectional view of a coaxial transmission line connector in accordance with a representative embodiment.

FIGS. 13B and 13C are perspective views of the coaxial transmission line connector of FIG. 13A.

FIG. 14A is a perspective view of an electrical connector for coupling signal transmission lines in accordance with a representative embodiment.

FIG. 14B includes cross-sectional views of the electrical connector for coupling signal transmission lines of FIG. 14A.

FIG. 14C is a perspective view of another electrical connector for coupling signal transmission lines in accordance with a representative embodiment.

FIG. 14D includes cross-sectional views of the electrical connector for coupling signal transmission lines of FIG. 14C.

FIG. 15A illustrates azimuthal symmetry for electrical connectors in accordance with a representative embodiment.

FIG. 15B includes cross sectional views of the electrical connector of shown in FIG. 15A.

FIG. 16A is a perspective view of a slotted electrical connector for coupling signal transmission lines in accordance with a representative embodiment.

FIG. 16B is a perspective view of a slotless electrical connector for coupling signal transmission lines in accordance with a representative embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only, and is not intended to be limiting. The defined terms are in addition to the technical and scientific meanings of the defined terms as commonly understood and accepted in the technical field of the present teachings.

Unless otherwise noted, when a first element (e.g., a signal transmission line) is said to be connected to a second element (e.g., another signal transmission line), this encompasses cases where one or more intermediate elements (e.g., an electrical connector) may be employed to connect the two elements to each other. However, when a first element is said to be directly connected to a second element, this encompasses only cases where the two elements are connected to each other without any intermediate or intervening devices. Similarly, when a signal is said to be coupled to an element, this encompasses cases where one or more intermediate elements may be employed to couple the signal to the element. However, when a signal is said to be directly coupled to an element, this encompasses only cases where the signal is directly coupled to the element without any intermediate or intervening devices.

As used in the specification and appended claims, the terms ‘a’, ‘an’ and ‘the’ include both singular and plural referents, unless the context clearly dictates otherwise. Thus, for example, ‘a device’ includes one device and plural devices. As used in the specification and appended claims, and in addition to their ordinary meanings, the terms ‘substantial’ or ‘substantially’ mean to within acceptable limits or degree. As used in the specification and the appended claims and in addition to its ordinary meaning, the term ‘approximately’ means to within an acceptable limit or amount to one having ordinary skill in the art. For example, ‘approximately the same’ means that one of ordinary skill in the art would consider the items being compared to be the same.

Relative terms, such as “above,” “below,” “top,” “bottom,” may be used to describe the various elements' relationships to one another, as illustrated in the accompanying drawings. These relative terms are intended to encompass different orientations of the elements thereof in addition to the orientation depicted in the drawings. For example, if an apparatus (e.g., a semiconductor package) depicted in a drawing were inverted with respect to the view in the drawings, an element described as “above” another element, for example, would now be “below” that element. Similarly, if the apparatus were rotated by 90° with respect to the view in the drawings, an element described “above” or “below” another element would now be “adjacent” to the other element; where “adjacent” means either abutting the other element, or having one or more layers, materials, structures, etc., between the elements.

In accordance with a representative embodiment, a signal transmission line comprises: a first electrical conductor; a second electrical conductor; a dielectric region between the first electrical conductor and the second electrical conductor; and an electrically thin resistive layer disposed within the dielectric region and disposed between the first electrical conductor and the second electrical conductor. The electrically thin resistive layer is configured to be substantially transparent to a substantially transverse-electromagnetic (TEM) mode of transmission, yet substantially completely attenuating higher order modes of transmission.

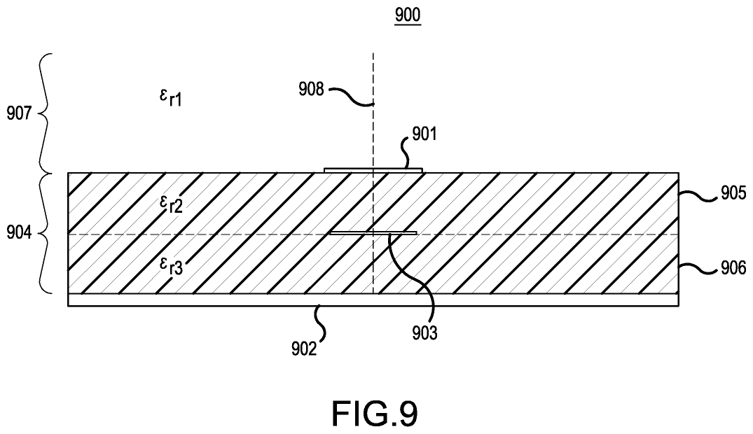

As will become clearer as the present description continues, the lowest order (and desired mode) of the transmission lines of the representative embodiments is a “substantially” TEM mode. To this end, a TEM mode is somewhat of an idealization that follows from the solutions to Maxwell's Equations. In reality, at any nonzero frequency, the “TEM mode” actually has small deviations from a purely transverse electric field due to the imperfect nature of the conductors of the transmission line. Also, inhomogeneity in the dielectric region(s) (e.g., comprising first and second dielectric layers 905, 906 as depicted in FIG. 9) will lead to dispersion and deviation from the behavior of an ‘ideal’ TEM mode, (which is technically dispersionless) in coaxial transmission lines, stripline, etc. at higher frequencies. As such, the term “substantially TEM” mode accounts for such deviations from the ideal behavior due to the environment of the transmission lines of the representative embodiments described below.

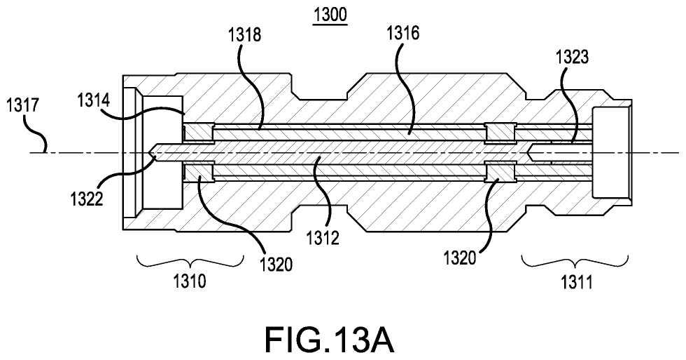

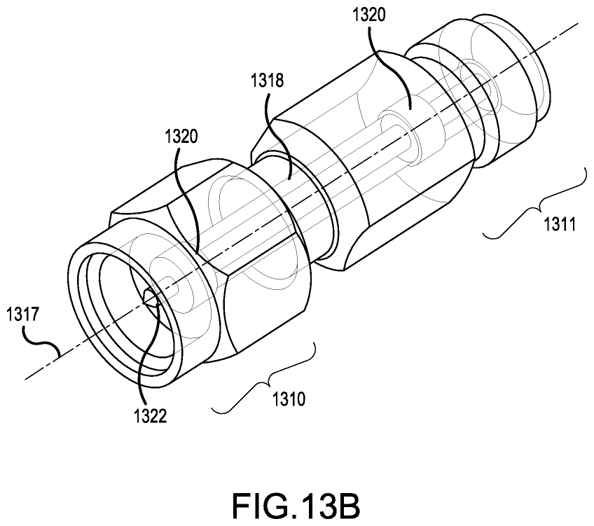

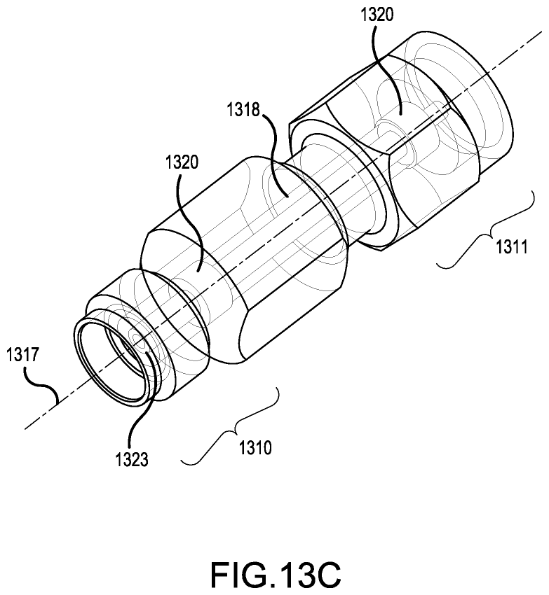

The present teachings are described initially in connection with representative embodiments that comprise a coaxial transmission line (or, variously coaxial cable). As will be appreciated as the present description continues, the comparatively symmetrical structure of the coaxial transmission line enables the description of various salient features of the present teachings in a comparatively straight-forward manner. However, it is emphasized that the present teachings are not limited to representative embodiments comprising coaxial transmission lines. Rather, and as described more fully below, the present teachings are contemplated for use in other types of transmission lines to include transmission lines with an inner conductor that is geometrically offset relative to an outer conductor, stripline transmission lines, and microstrip transmission lines, which are transmitting substantially TEM modes. Moreover, the present teachings are contemplated for devices used to effect connections between a transmission line and an electrical device, or other transmission line (e.g., electrical connectors, adapters, attenuators, etc.). By way of example, the ends of a coaxial transmission line may terminate at a coaxial electrical connector (see FIGS. 13A-13C) that is designed to maintain a coaxial form across the connection and have substantially the same impedance as the coaxial transmission line to reduce reflections back into the coaxial transmission line. Connectors are usually plated with high-conductivity metals such as silver or tarnish-resistant gold.

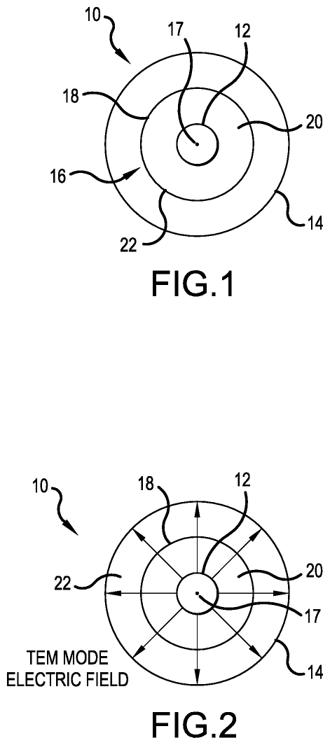

Referring now to FIGS. 1-3, a coaxial transmission line 10 in accordance with a representative embodiment will now be described. The coaxial transmission line 10 is shown in the drawings as a coaxial cable, for example. The coaxial transmission line 10 includes an inner electrical conductor 12 (sometimes referred to as a first electrical conductor), an outer electrical conductor 14 (sometimes referred to as a second electrical conductor), a dielectric region 16 between the inner electrical conductor 12 and the outer electrical conductor 14, and an electrically thin resistive layer 18 within the dielectric region 16 and concentric with the inner electrical conductor 12 and the outer electrical conductor 14.

In representative embodiments, the electrically thin resistive layer 18 is continuous and extends along the length of the coaxial transmission line 10. The continuity of the electrically thin resistive layer is common to the transmission lines of other representative embodiments described herein. Alternatively, the electrically thin resistive layer 18, as well the electrically thin resistive layer of other representative embodiments may be discontinuous, and thereby have gaps along the length of the particular transmission line.

The inner electrical conductor 12 has a common propagation axis 17 with, the outer electrical conductor 14. Similarly, the inner conductor and the outer electrical conductor 14 share a common geometric center (e.g., a point on the common propagation axis 17). Moreover, the coaxial transmission line 10 is substantially circular in cross-section. Generally, the term ‘coaxial’ means the various layers/regions of a transmission line have a common propagation axis. Likewise the term ‘concentric’ means layers/regions of a transmission line have the same geometric center. As will be appreciated as the present description continues, the transmission lines of some representative embodiments are coaxial and concentric, whereas in other representative embodiments the transmission lines are not concentric. Finally, the transmission lines of the representative embodiments are not limited to those circular in cross-section. Rather, transmission lines with other cross-sections are contemplated, including but not limited to, rectangular and elliptical cross-sections.

As may be appreciated by those skilled in the art, the inner electrical conductor 12 and the outer electrical conductor 14 may be any suitable electrical conductor such as a copper wire, or other metal, metal alloy, or non-metal electrical conductor. The dielectric materials or layers contemplated for use in dielectric region 16 include, but are not limited to glass fiber material, plastics such as polytetrafluoroethylene (PTFE), low-k dielectric material with a reduced loss tangent (e.g., 10⁻²), ceramic materials, liquid crystal polymer (LCP), or any other suitable dielectric material, including air, and combinations thereof. A protective sheath can include a protective plastic coating or other suitable protective material, and is preferably a non-conductive insulating sleeve. In representative embodiments described below, the dielectric region 16 may comprise one or more dielectric layers. Notably, the number of dielectric layers described in the various representative embodiments is generally illustrative, and more (than one) or fewer layers are contemplated. However, generally the dielectric constants of the various dielectric layers are substantially the same in order to propagate substantially TEM modes of propagation.

The coaxial transmission line 10 differs from other shielded cable used for carrying lower-frequency signals, such as audio signals, in that the dimensions of the coaxial transmission line 10 are controlled to give a substantially precise, substantially constant spacing between the inner electrical conductor 12 and the outer electrical conductor 14.

Coaxial transmission line 10 is often used as a transmission line for radio frequency signals. Applications of coaxial transmission line 10 include feedlines connecting radio transmitters and receivers with their antennas, computer network (Internet) connections, and distributing cable television signals. In radio-frequency applications, the electric and magnetic signals propagate primarily in the substantially transverse electric magnetic (TEM) mode, which is the single desired mode to be propagated by the transmission line. In a substantially TEM mode, the electric and magnetic fields are both substantially perpendicular to the direction of propagation. However, above a certain cutoff frequency, transverse electric (TE) or transverse magnetic (TM) modes, or both, can also propagate, as they do in a waveguide. It is usually undesirable to transmit signals above the cutoff frequency, since it may cause multiple modes with different phase velocities to propagate, interfering with each other. The average of the circumference between the inner electrical conductor 12 and the inside of the outer electrical conductor 14 is roughly inversely proportional to the cutoff frequency.

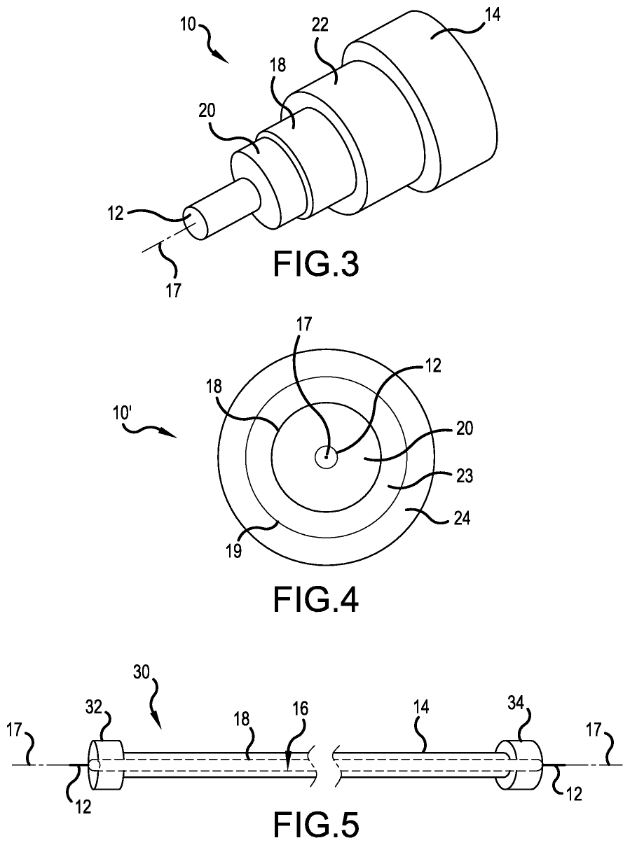

As illustrated in FIGS. 2 and 3, the electrically thin resistive layer 18 is an electrically resistive layer selected and configured, as described below, to be substantially transparent to a substantially transverse-electromagnetic (TEM) mode of transmission, while substantially completely attenuating higher order modes of transmission. Generally, substantially completely attenuating means the coaxial transmission line 10, or other transmission line according to representative embodiments described herein, is designed to accommodate a predetermined threshold of relative attenuation between the desired substantially TEM mode and the undesired higher order modes. As will be appreciated, among other design consideration, this predetermined threshold is realized through the selection of the appropriate thickness (e.g., via the skin depth described below) and resistivity of the electrically thin resistive layer 18. For example, in an application where RF frequencies up to 10² GHz are relevant and the transmission length is on the order of 10¹ cm, the threshold of relative attenuation requires a TEM attenuation constant of approximately 0.1 m⁻¹, but attenuation of the higher order modes by more than approximately 100 m⁻¹, and usefully over approximately 1000 m⁻¹ are contemplated. On the other hand, in an application where the highest frequency of operation is only a few GHz (or less) and the transmission length is tens of meters, the threshold of relative attenuation requires a TEM attenuation constant of approximately 0 m⁻¹ to approximately 0.01 m⁻¹, while attenuating the higher order modes by at least approximately 1.0 m⁻¹, but usefully by more than approximately 10 m⁻¹ are contemplated. It is emphasized that these examples are merely illustrative, and are not intended to be limiting of the present teachings.

As used herein, an “electrically thin” layer is one for which the layer thickness is less than the skin depth δ at the (highest) signal frequency of interest. This insures that the substantially TEM mode is minimally absorbed. The skin depth is given by δ=1/√(πfμσ), where δ is in meters, f is the frequency in Hz, μ is the magnetic permeability of the layer in Henrys/meter, and σ is the conductivity of the layer in Siemens/meter.

So for the discussion herein, if t is the physical thickness of the electrically thin resistive layer 18, it is “electrically thin” if t<δₘᵢₙ=1/√(πfₘₐₓμσ), where δₘᵢₙ is the skin depth calculated at the maximum frequency fₘₐₓ. For example, suppose fₘₐₓ=200 GHz, the layer is nonmagnetic and hence μ=μ₀=the vacuum permeability=4π*10−7 Henrys/meter, and the conductivity is 100 Siemens/meter. Then δₘᵢₙ=112.5 μm, so a resistive layer thickness t of 25 μm would be considered electrically thin in this case. Recapitulating, the electrically thin resistive layer 18 is electrically thin when its thickness is less than a skin depth at a maximum operating frequency of the coaxial transmission line 10.

The dielectric region 16 may comprise an inner dielectric material 20 between the inner electrical conductor 12 and the electrically thin resistive layer 18, and an outer dielectric material 22 between the electrically thin resistive layer 18 and the outer electrical conductor 14. In various embodiments, the inner dielectric material 20 and the outer dielectric material 22 have approximately the same thickness. In some embodiments, a thickness of the inner dielectric material 20 is approximately twice a thickness of the outer dielectric material 22.

The electrically thin resistive layer 18 may be an electrically thin resistive coating on the inner dielectric material 20. The electrically thin resistive layer 18 illustratively includes at least one of TaN, WSiN, resistively-loaded polyimide, graphite, graphene, transition metal dichalcogenide (TMDC), nichrome (NiCr), nickel phosphorus (NiP), indium oxide, and tin oxide. Notably, however, other materials within the purview of one of ordinary skill in the art having the benefit of the present teachings, are contemplated for use as the electrically thin resistive layer 18.

Transition metal dichalcogenides (TMDCs) include: HfSe₂, HfS₂, SnS₂, ZrS₂, MoS₂, MoSe₂, MoTe₂, WS₂, WSe₂, WTe₂, ReS₂, ReSe₂, SnSe₂, SnTe₂, TaS₂, TaSe₂, MoSSe, WSSe, MoWS₂, MoWSe₂, PbSnS₂. The chalcogen family includes the Group VI elements S, Se and Te.

The electrically thin resistive layer 18 may have an electrical sheet resistance between 20-2500 ohms/sq and preferably between 20-200 ohms/sq.

With additional reference to FIG. 4, another embodiment of a coaxial transmission line 10′ will be described. In this embodiment, an additional electrically thin resistive layer 19 is included within the dielectric region and concentric with the inner electrical conductor 12 and the outer electrical conductor 14. In such an embodiment, the dielectric region includes the inner dielectric material 20, a middle dielectric material 23, and an outer dielectric material 24. Such dielectric materials may include the same or different materials. Multiple electrically thin resistive layers may be included based upon desired attenuation characteristics.

Adding a second electrically thin resistive layer, perhaps ⅔ of the way in from the outer electrical conductor 14 may be better positioned to attenuate some higher order modes, and may be beneficial in the presence of multiple discontinuities or with a poorly matched load. It may also be useful to allow a cable to be bent multiple times. So, it may be desired to include the additional electrically thin resistive layer 19 between electrically thin resistive layer 18 and the outer electrical conductor 14. However, the benefits of the additional electrically thin resistive layer 19 must be weighed against the possible disadvantage that the additional electrically thin resistive layer 19 may add some insertion loss for the dominant substantially TEM mode.

With additional reference to FIG. 5, another embodiment is described. Here, the inner electrical conductor 12, outer electrical conductor 14 and dielectric region 16 define a length of coaxial cable 30, with coaxial connectors 32, 34 at opposite ends of the coaxial cable 30. The electrically thin resistive layer 18 extends within the entire length of coaxial cable 30 and within the coaxial connectors 32, 34.

Also, in other embodiments, the inner electrical conductor 12, outer electrical conductor 14 and dielectric region 16 may define a length of micro-coaxial transmission line.

Having set forth the various structures of the exemplary embodiments above, features, advantages and analysis will now be discussed. The example embodiments are directed to a coaxial transmission line 10, 10′, e.g. a coaxial cable 30, in which a concentric electrically thin resistive layer 18 is sandwiched somewhere within the insulating (dielectric) region 16 that separates the inner electrical conductor 12 and outer electrical conductor 14. Namely, in addition to the typical inner and outer electrical conductors 12/14 made out of metals with high conductivity, we now have an inner dielectric and an outer dielectric separated by an electrically thin (in this case cylindrical) resistive layer 18. All regions, inner electrical conductor 12, inner dielectric material 20, electrically thin (cylindrical) resistive layer 18, outer dielectric material 22, and outer electrical conductor 14 are concentric. The term coaxial and/or concentric means that the layers/regions have the same axis/center. This is not limited to any particular cross-section. Circular, rectangular and other cross sections are contemplated herein. By way of example, the inner and outer conductors may have other cross-sectional shapes, such as rectangular (described below). Alternatively, the inner and outer conductors may have different cross-sectional shapes (e.g., the inner conductor may be circular in cross-section, and the outer conductor may be rectangular in cross-section). Regardless of the shapes of the inner and outer conductors, the electrically thin resistive layer is selected to have a shape so that the electric field lines of the substantially TEM mode are substantially perpendicular (i.e., substantially parallel to the normal of the electrically thin resistive layer) at each point of incidence, and to be substantially transparent to the substantially TEM mode of transmission, while substantially attenuating higher order modes of transmission.

As in conventional coax, the desired substantially transverse electromagnetic (TEM) features an everywhere substantially radially directed electric field, as shown in FIG. 2. All higher order modes, whether transverse electric (TE) or transverse magnetic (TM), fail to have this property.

In particular, all TM modes have a strong longitudinal (along the axis) component of electric field. These longitudinal electric vectors will generate axial RF currents in the resistive cylinder, leading to high ohmic dissipation of the TM modes. Conversely, the TE modes have pronounced azimuthal (i.e., clockwise or counterclockwise directed about the axis) electric field vectors, which in turn generate local azimuthal currents in the resistive cylinder. Again, since an electrically thin resistive sheet 1418 is not a good electrical conductor, high ohmic dissipation of the TE modes beneficially results.

The substantially TEM mode, on the other hand, suffers little ohmic dissipation because the thin resistive cylinder does not allow radial currents to flow.

An important advantage of the embodiments of the present teachings is the realization of comparatively larger dimensions for both the inner and outer electrical conductors 1412, 1414 to be used at higher frequencies. This results in less electrically conductive loss for the desired broadband substantially TEM mode due to reduced current crowding. It also allows the potential use of sturdier connectors and a sturdier cable itself to a given maximum TEM frequency. As opposed to waveguide technology, the present embodiments are still a truly broadband (DC to a very high frequency, e.g. millimeter waves or sub-millimeter waves) conduit.

In practice, the industry likes to deal with 50-ohm cables at millimeter-wave frequencies. The usual dielectric PTFE has a relative dielectric constant of approximately 1.9—the exact value depends on the type of PTFE and the frequency, but this is close enough for this discussion. For this dielectric value in conventional coaxial cable 30, the ratio of outer electrical conductor 1314 ID to inner electrical conductor 12 OD=3.154 to achieve 50Ω characteristic impedance.

An example of a practical frequency extension goal is now discussed. 1.85-mm cable is single-mode up to approximately ˜73 GHz. It would be very useful to extend this frequency almost threefold to 220 GHz, for example. A relevant computation is to identify how many and which TE and TM modes between 73 GHz and 220 GHz have to be attenuated by the resistive cylindrical sheet.

A simple way to do this accounting is to compute the dimensionless eigenvalues k_{c}a for the higher-order modes, where k_{c} is the cutoff wavenumber=2π/λ_{c} and 2a is the outer electrical conductor 1314 ID. Here λ_{c} is the free-space cutoff wavelength=c/f_{c}, where f_{c} is the cutoff frequency and c is the speed of light in vacuum. The lowest eigenvalue corresponds to the ˜73 GHz cutoff of the first higher-order mode, which happens to be the TE11 mode. Any eigenvalue within a factor of 3 of the lowest eigenvalue indicates a mode that should be attenuated. Eigenvalues more than a factor of 3 greater than the lowest eigenvalue correspond to modes that are still in cutoff, even at 220 GHz.

The reason for using dimensionless eigenvalues is that the same reasoning can be scaled to other cases. For example, it may be desired to extend the operating frequency of 1-mm cable, which is single-mode to ˜120 GHz, to ˜360 GHz. The lowest eigenvalue then corresponds to the ˜120 GHz cutoff of the TE₁₁ mode in 1-mm cable.

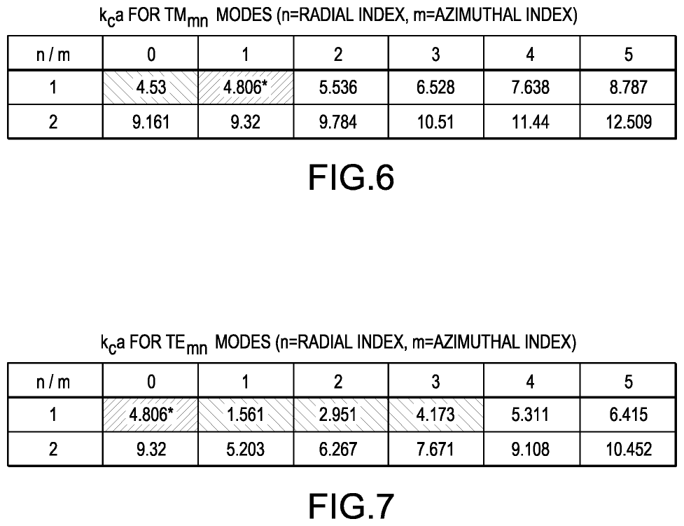

The tables in FIGS. 6 and 7 show the accounting for the TE and TM modes, respectively. In FIG. 6, which shows the eigenvalues of TE modes for a 50-ohm Teflon-filled coax, the eigenvalues at TE₁₁, TE₁₂, and TE₁₃ correspond to modes that should be attenuated. The other eigenvalues are modes still in cutoff except for TE₁₀ which comes close to the arbitrary “thrice 1st cutoff frequency” rule in this example. In other words, TE₁₀ is barely still cutoff at 220 GHz, so resistive attenuation here may be desirable if the maximum operating frequency needs to be pushed just a bit higher.

The table of FIG. 7 shows the eigenvalues of TM modes for a 50-ohm Teflon-filled coax, and it can be seen that there are only a handful of modes to be concerned with resistively attenuating. Beneficially, the sheet resistance and radius of the resistive cylinder can be selected to minimally attenuate the substantially TEM mode while maximally attenuating higher order modes (e.g., the TE₁₁ mode).

Let r be the radius of the resistive cylinder. To keep the discussion generic (as opposed to dealing only with 1.85-mm cable), the designer can hone the sheet resistance and the dimensionless ratio a/r, where 2a is the inner diameter ID of the outer electrical conductor 14. Sheet resistance in the range of approximately 20 Ω/sq to approximately 200 Ω/sq and a/r values in the range approximately 1.2 to approximately 2.4 are effective. The resistive cylinder may be substantially midway between the inner electrical conductor 12 and the outer electrical conductor 14.

An example of a way to construct the geometry is to roll an electrically thin resistive sheet 1418 around the inner dielectric material 20, already with the inner electrical conductor 12 inside its core. Then the outer dielectric material 22 can be slipped over this partial assembly. Finally the outer electrical conductor 14 can be slipped over on the outside.

Graphite/graphene, MoS2, WS2, and MoSe2 are available in lubricant form, which may lead to an alternative construction method. The inner dielectric material 20 (e.g. a cylinder) can be lubricated with the desired resistive lubricant. The lubrication coating thickness is chosen to produce the desired sheet resistance, depending on the electrical resistivity of the lubricant. The outer dielectric material 22, e.g. initially including two half-cylinders, is then clam-shelled about the lubricated inner dielectric material 20. Finally the outer electrical conductor 14 is slipped over the outer dielectric material 22. With a snug fit, the outer electrical conductor 14, e.g. a cylinder, will hold the half shells in place so no adhesive may even be necessary.

A variation of the embodiments of the present teachings is to provide the electrically thin resistive layer 18 only in the “perturbed” lengths of the coaxial cable. That is, in the truly straight sections of a coaxial reach, all the modes are orthogonal so they don't couple to each other. It is only where the ideal coax is perturbed, e.g., at connectors and in bends, that the modes are deformed from their textbook distributions and cross-coupling can occur. Therefore, another strategy is to include the electrically thin resistive layer 18 only in/near the connectors and in pre-bent regions and to advise the cable user to avoid bending prescribed straight sections that may omit the electrically thin resistive layer 18. This approach has the advantage of reducing or minimizing attenuation of the substantially TEM mode which may be especially important for long cables or at very high frequencies where the skin depth of the substantially TEM mode approaches the thickness of the resistive sheet 1418.

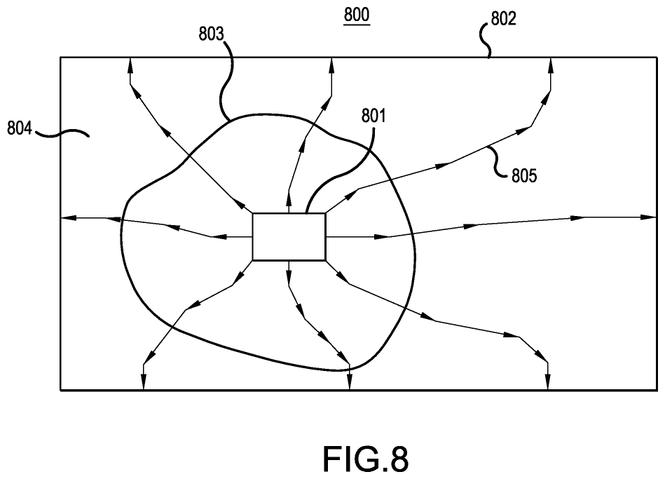

FIG. 8 is a cross-sectional view of a transmission line 800 in accordance with a representative embodiment. Many aspects and details of the transmission line 800 are common to the transmission lines described in connection with the representative embodiments of FIGS. 1-7, above, and may not be repeated in order to avoid obscuring the presently described representative embodiments.

The transmission line 800 comprises a first electrical conductor 801, which functions as a signal line, and a second electrical conductor 802 disposed thereabout, which functions as a ground plane. An electrically thin resistive layer 803 is disposed in a dielectric region 804 and between the first electrical conductor 801 and the second electrical conductor 802. Notably, the dielectric region 804 comprises one or more of the dielectric materials described above. If more than one material is used in the dielectric region 804, their dielectric constants are approximately the same.

The transmission line 800 shows certain features alluded to above, and contemplated by the present teachings. Notably, some of these features may be foregone, with the resulting structure contemplated by the present teachings. The second electrical conductor 802, which is an outer electrical conductor, is neither circular nor elliptical in cross-section. Rather, the second electrical conductor 802 is substantially rectangular. Alternatively, the second electrical conductor 802 could have other cross-sectional shapes, such as square, or polygonal. As can be appreciated, the cross-sectional shape of the second electrical conductor 802, among other things, dictates the propagated single mode, in this case a substantially TEM mode, and thus the orientation of the electric field lines. The electrically thin resistive layer 803 has a shape that is selected so that electric field lines 805 of the substantially TEM mode are incident thereon orthogonally (or parallel to the normal to the surface of the electrically thin resistive layer). As in representative embodiments described above in connection with FIGS. 1-7, the electrically thin resistive layer 803 is configured to be substantially transparent to a substantially transverse-electromagnetic (TEM) mode of transmission, while substantially completely attenuating higher order modes of transmission.

The first electrical conductor 801 is offset relative to the second electrical conductor 802, and therefore does not share a common geometric center. This is merely illustrative, and, as noted above, other contemplated (e.g., the first and second electrical conductors 801, 802 share a common geometric center). Moreover, the first electrical conductor 801 illustratively has a substantially rectangular cross-section. This too is not essential and the first electrical conductor 801 may have other cross-sectional shapes, such as circular or elliptical. As can be appreciated from the present teachings, the selection of the shapes of the various components of the transmission lines impacts the orientation of the electric field lines of the substantially TEM mode. The electrically thin resistive layer 803 is selected to have a shape so that the electric field lines of the substantially TEM mode are substantially perpendicular (i.e., substantially parallel to the normal to the electrically thin resistive layer) at each point of incidence, and to be substantially transparent to the substantially TEM mode of transmission, while substantially attenuating higher order modes of transmission.

FIG. 9 is a cross-sectional view a transmission line 900 in accordance with a representative embodiment. Many aspects and details of the transmission line 900 are common to the transmission lines described in connection with the representative embodiments of FIGS. 1-8, above, and may not be repeated in order to avoid obscuring the presently described representative embodiments.

The transmission line 900 is illustratively a microstrip transmission line, comprising a first electrical conductor 901 (i.e., the signal conductor), a second electrical conductor 902 (i.e., the ground conductor) disposed below the first electrical conductor 901. An electrically thin resistive layer 903 is disposed in a substrate 904, which comprises a first dielectric layer 905 and a second dielectric layer 906. A superstrate 907 is disposed over the substrate 904. The first and second dielectric layers 905, 906 have dielectric constants εᵣ₂ and εᵣ₃, whereas the superstrate 907 has a dielectric constant εᵣ₁ less than or equal to that of the substrate 904. By way of example, εᵣ₂ is substantially the same as εᵣ₃.

The bisecting plane 908 of the first electrical conductor 901 also bisects the electrically thin resistive layer 903. The most intense electric fields occur in the bisecting plane 908, and, as such, hence it is useful that the electrically thin resistive layer 903 be perpendicular to the bisecting plane 908. Also, for most effective attenuation of potentially interfering higher order modes, the electrically thin resistive layer 903 is best situated symmetrically about the bisecting plane 908.

The electrically thin resistive layer 903 is selected to have a shape and orientation so that the electric field lines (not shown) of the desired substantially TEM mode are substantially perpendicular (i.e., parallel to the normal to the electrically thin resistive layer) at each point of incidence, and to be substantially transparent to the substantially TEM mode of transmission, while substantially attenuating higher order modes of transmission.

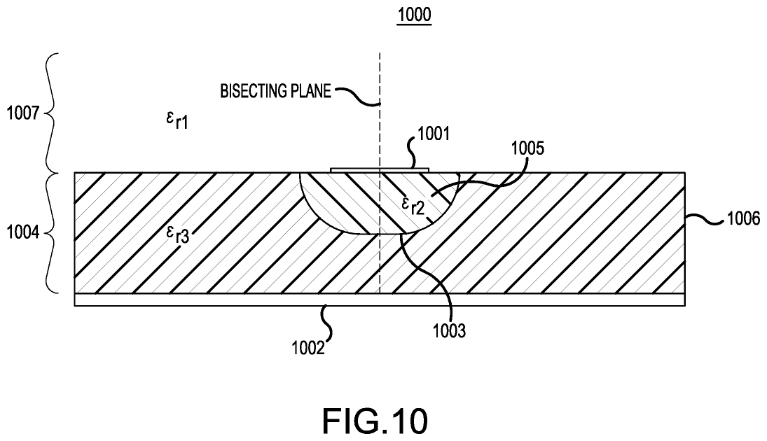

FIG. 10 is a cross-sectional view a transmission line 1000 in accordance with a representative embodiment. Many aspects and details of the transmission line 1000 are common to the transmission lines described in connection with the representative embodiments of FIGS. 1-9, above, and may not be repeated in order to avoid obscuring the presently described representative embodiments.

The transmission line 1000 is illustratively a microstrip transmission line, comprising a first electrical conductor 1001 (i.e., the signal conductor), a second electrical conductor 1002 (i.e., the ground conductor) disposed below the first electrical conductor 1001. An electrically thin resistive layer 1003 is disposed in a substrate 1004, which comprises a first dielectric layer 1005 and a second dielectric layer 1006. A superstrate 1007 is disposed over the substrate 1004. The first and second dielectric layers 1005, 1006 have dielectric constants εᵣ₂ and εᵣ₃, whereas the superstrate 1007 has a dielectric constant εᵣ₁ less than or equal to that of the substrate 1004. By way of example, εᵣ₂ is substantially the same as εᵣ₃.

The electrically thin resistive layer 1003 is selected to have a shape and orientation so that the electric field lines (not shown) of the substantially TEM mode are substantially perpendicular (i.e., substantially parallel to the normal to the electrically thin resistive layer) at each point of incidence, and to be substantially transparent to the substantially TEM mode of transmission, while substantially attenuating higher order modes of transmission. Notably, and unlike the electrically thin resistive layer 903, electrically thin resistive layer 1003 is curved to follow a magnetic field line contour of the substantially TEM mode all the way to the interface between the substrate 1004 and the superstrate 1007. As will be appreciated by one of ordinary skill in the art, in a substantially TEM mode the electric and magnetic field lines are substantially mutually perpendicular, and their cross product vector (i.e., the Poynting Vector) points in the propagation direction. Hence, if the resistive sheet follows a magnetic field contour, it is automatically everywhere-perpendicular to the electric field.

One benefit of the transmission line 1000 is its greater damping of the higher order modes because of the electrically thin resistive layer 1003 that is oriented relative to the B-field lines of the higher order modes.

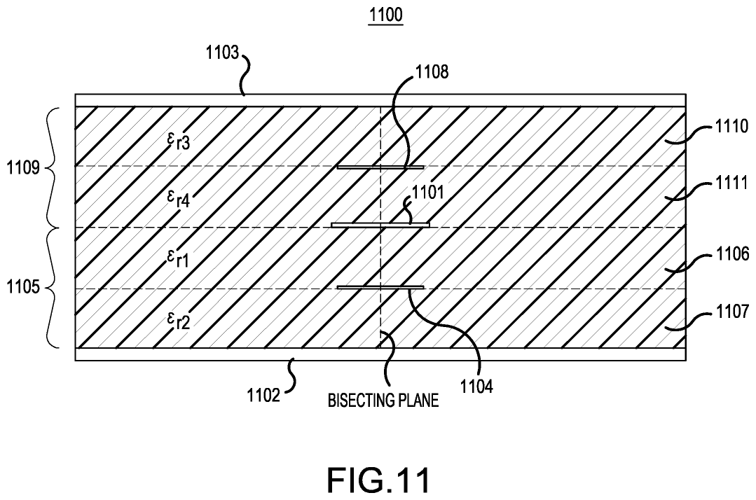

FIG. 11 is a cross-sectional view of a transmission line 1100 in accordance with a representative embodiment. Many aspects and details of the transmission line 1100 are common to the transmission lines described in connection with the representative embodiments of FIGS. 1-10, above, and may not be repeated in order to avoid obscuring the presently described representative embodiments.

The transmission line 1100 is illustratively a stripline transmission line, comprising a first electrical conductor 1101 (i.e., the signal conductor), a second electrical conductor 1102 (i.e., the lower ground conductor) disposed below the first electrical conductor 1101, and a third electrical conductor 1103 (i.e., the upper ground conductor). As is known, ground-to-ground vias (not shown) may be used to ensure the second and third electrical conductors 1102, 1103 are maintained at the same electrical potential.

A first electrically thin resistive layer 1104 is disposed beneath the first electrical conductor 1101 in a substrate 1105, which comprises a first dielectric layer 1106 and a second dielectric layer 1107. A second electrically thin resistive layer 1108 is disposed above the first electrical conductor 1101 in a superstrate 1109, which comprises 1 third dielectric layer 1110 and a fourth dielectric layer 1111. The first˜fourth dielectric layers 1106, 1107, 1110, 1111, respectively have dielectric constants εᵣ₁, εᵣ₂, εᵣ₃ and εᵣ₄, respectively.

In accordance with a representative embodiment, the dielectric constants of the first˜fourth dielectric layers 1106, 1107, 1110, 1111 are substantially the same, hence the lowest order mode of propagation is substantially TEM.

The first and second electrically thin resistive layers 1104, 1108 are selected to have a shape and orientation so that the electric field lines (not shown) of the substantially TEM mode are substantially perpendicular (i.e., substantially parallel to the normal to the electrically thin resistive layer) at each point of incidence, and to be substantially transparent to the substantially TEM mode of transmission, while substantially attenuating higher order modes of transmission.

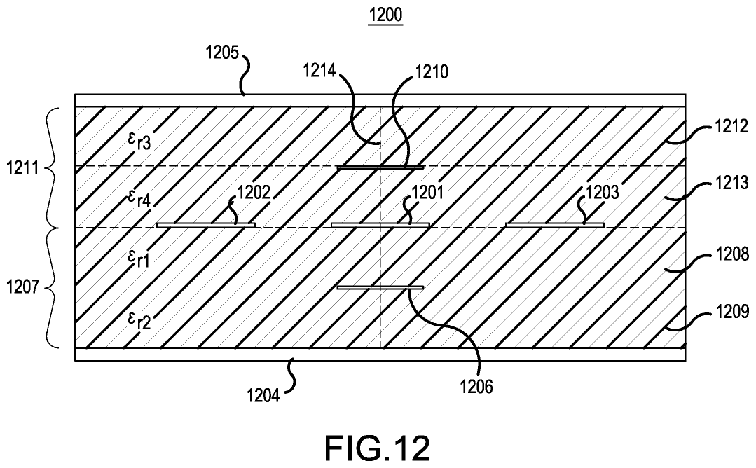

FIG. 12 is a cross-sectional view of a transmission line 1200 in accordance with a representative embodiment. Many aspects and details of the transmission line 1200 are common to the transmission lines described in connection with the representative embodiments of FIGS. 1-11, above, and may not be repeated in order to avoid obscuring the presently described representative embodiments.

The transmission line 1200 is illustratively a stripline transmission line, comprising a first electrical conductor 1201 (i.e., the signal conductor), a second electrical conductor 1202 (i.e., a first coplanar ground conductor) disposed adjacent to the first electrical conductor 1201, and a third electrical conductor 1203 (i.e., a second coplanar ground conductor).

A fourth electrical conductor 1204 (i.e., the lower ground conductor) is disposed below the first electrical conductor 1201, and a fifth electrical conductor 1205 (i.e., the upper ground conductor) is disposed above the first electrical conductor 1201. As noted above, ground-to-ground vias (not shown) may be used to ensure the second˜fifth electrical conductors 1202-1205 are maintained at the same electrical potential.

A first electrically thin resistive layer 1206 is disposed beneath the first electrical conductor 1201 in a substrate 1207, which comprises a first dielectric layer 1208 and a second dielectric layer 1209. A second electrically thin resistive layer 1210 is disposed above the first electrical conductor 1201 in a superstrate 1211, which comprises a third dielectric layer 1212 and a fourth dielectric layer 1213. The first˜fourth dielectric layers 1208, 1209, 1212, 1213, respectively, have dielectric constants εᵣ₁, εᵣ₂, εᵣ₃ and εᵣ₂, respectively.

In accordance with a representative embodiment, the dielectric constants of the first˜fourth dielectric layers 1208, 1209, 1212, 1213 are substantially the same, hence the lowest order mode of propagation is substantially TEM.

The first and second electrically thin resistive layers 1206, 1210 are selected to have a shape and orientation so that the electric field lines (not shown) of the substantially TEM mode are substantially perpendicular (i.e., substantially parallel to the normal to the electrically thin resistive layer) at each point of incidence, and to be substantially transparent to the substantially TEM mode of transmission, while substantially attenuating higher order modes of transmission.

FIGS. 13A, and 13B and 13C depict a cross-sectional view, and perspective views, respectively of an electrical connector 1300 in accordance with a representative embodiment will now be described. Notably, many aspects and details of the transmission lines of the representative embodiments described above are common to the electrical connector 1300. These common aspects and details are often not repeated in the presently described representative embodiment.

The electrical connector 1300 is shown in the drawings as a coaxial electrical connector, for example. It is emphasized that other electrical connectors are contemplated by the present teachings.

In the presently described representative embodiment, the electrical connector is a male-to-female connector, comprising a male end 1310, and a female end 1311. As will be appreciated by one of ordinary skill in the art, all aspects of electrical connectors of the present teachings are provided through the presently described representative embodiment. As such, a male connector configured to terminate a signal transmission line may be fashioned through straight-forward adaptation of the male end 1310; and a female connector configured to terminate a signal transmission line may be fashioned through straight-forward adaptation of the female end 1311.

The electrical connector 1300 includes an inner electrical conductor 1312 (sometimes referred to as a first electrical conductor), an outer electrical conductor 1314 (sometimes referred to as a second electrical conductor), a dielectric region 1316 between the inner electrical conductor 1312 and the outer electrical conductor 1314, and an electrically thin resistive layer 1318 within the dielectric region 1316 and concentric with the inner electrical conductor 1312 and the outer electrical conductor 1314. As shown in FIG. 13A, the inner electrical conductor 1312 terminates in a male conductor 1322 on the male end 1310, and in a female conductor 1323 on the female end 1311.

In representative embodiments, the electrically thin resistive layer 1318 is continuous and extends along the length of the electrical connector 1300. The continuity of the electrically thin resistive layer is common to the transmission lines of other representative embodiments described herein. Alternatively, the electrically thin resistive layer 1318, as well the electrically thin resistive layer of other representative embodiments may be discontinuous, and thereby having gaps along the length of the particular transmission line.

The inner electrical conductor 1312 has a common propagation axis 1317 with the outer electrical conductor 1314. Similarly, the inner conductor and the outer electrical conductor 1314 share a common geometric center (e.g., a point on the common propagation axis 1317). Moreover, the electrical connector 1300 is substantially circular in cross-section. Generally, the term ‘coaxial’ means the various layers/regions of a transmission line have a common propagation axis Likewise the term ‘concentric’ means layers/regions of a transmission line have the same geometric center. As will be appreciated as the present description continues, the transmission lines of some representative embodiments are coaxial and concentric, whereas in other representative embodiments the transmission lines are not concentric. Finally, the transmission lines of the representative embodiments are not limited to those circular in cross-section. Rather, transmission lines with other cross-sections are contemplated, including but not limited to, rectangular and elliptical cross-sections.

As depicted in FIG. 13A, the inner electrical conductor 1312 extends beyond the terminus of the body of the electrical connector 1300 to facilitate connection with a female conductor (not shown) on another electrical connector (not shown). In this manner, the electrical connector 1300 can function as a termination of a transmission line comprising an electrically thin resistive layer, such as those described above in connection with representative embodiment.

The female conductor 1323, which, as shown more clearly in FIG. 13C, has a hollow interior, and is configured to connect with a male conductor (not shown) on another electrical connector (not shown).

As may be appreciated by those skilled in the art, the inner electrical conductor 1312 and the outer electrical conductor 1314 may be any suitable electrical conductor such as a copper wire, or other metal, metal alloy, or non-metal electrical conductor.

In certain embodiments, the dielectric material provided in the dielectric region 1316 is air. In such embodiments, in order to provide structural propagate, and thereby ensure separation of the inner electrical conductor 1312, the electrically thin resistive layer 1318, and the outer electrical conductor 1314, dielectric beads 1320 are disposed between the inner electrical conductor 1312 and the outer electrical conductor 1314 as shown. These dielectric beads may be formed of a known material suitable for the intended purposed of the electrical connector 1300, for example a dielectric material described below.

Alternatively, if air is not used as the dielectric material one or more layers of dielectric material may be provided in the dielectric region 1316. Such materials contemplated for use in dielectric region 1316 include, but are not limited to glass fiber material, plastics such as polytetrafluoroethylene (PTFE), low-k dielectric material with a reduced loss tangent (e.g., 10⁻²), ceramic materials, liquid crystal polymer (LCP), or any other suitable dielectric material, including air, and combinations thereof. A protective sheath can include a protective plastic coating or other suitable protective material, and is preferably a non-conductive insulating sleeve. In representative embodiments described below, the dielectric region 1316 may comprise one or more dielectric layers. Notably, the number of dielectric layers described in the various representative embodiments is generally illustrative, and more (than one) or fewer layers are contemplated. However, generally the dielectric constants of the various dielectric layers are substantially the same in order to propagate substantially TEM modes of propagation.

The electrical connector 1300 differs from other shielded electrical connectors used for carrying lower-frequency signals, such as audio signals, in that the dimensions of the electrical connector 1300 are controlled to give a substantially precise, substantially constant spacing between the inner electrical conductor 1312 and the outer electrical conductor 1314.

Electrical connector 1300 is often used to connect signal transmission lines for radio frequency (RF) signals and higher. To this end, the electrical connector 1300 is configured for use in RF, microwave and millimeter wave applications. Applications of electrical connector 1300 include routing high frequency signals in an electronic test and measurement instrument, and connecting between an electronic test and measurement instrument and a DUT (device under test), connecting radio transmitters and receivers with their antennas, computer network (Internet) connections, and distributing cable television signals. In radio-frequency applications, the electric and magnetic signals propagate primarily in the substantially transverse electric magnetic (TEM) mode, which is the single desired mode to be propagated by the electrical connector 1300 and transmission lines connected thereto. In a substantially TEM mode, the electric and magnetic fields are both substantially perpendicular to the direction of propagation. However, above a certain cutoff frequency, transverse electric (TE) or transverse magnetic (TM) modes, or both, can also propagate, as they do in a waveguide. It is usually undesirable to transmit signals above the cutoff frequency, since it may cause multiple modes with different phase velocities to propagate, interfering with each other. The average of the circumference between the inner electrical conductor 1312 and the inside of the outer electrical conductor 1314 is roughly inversely proportional to the cutoff frequency.

The electrically thin resistive layer 1318 is substantially identical to those described above in connection with other representative embodiments. The electrically thin resistive layer 1318 is an electrically resistive layer selected and configured, as described above in connection with other representative embodiments, to be substantially transparent to a substantially transverse-electromagnetic (TEM) mode of transmission, while substantially completely attenuating higher order modes of transmission. Generally, as described above in connection with various signal transmission lines of representative embodiments, substantially completely attenuating means the electrical connector 1300 is designed to accommodate a predetermined threshold of relative attenuation between the desired substantially TEM mode and the undesired higher order modes. As will be appreciated, among other design consideration, this predetermined threshold is realized through the selection of the appropriate thickness (e.g., via the skin depth described below) and resistivity of the electrically thin resistive layer 1318. For example, in an application where RF frequencies up to 10² GHz are relevant and the transmission length is on the order of 10¹ cm, the threshold of relative attenuation requires a TEM attenuation constant of approximately 0.1 m⁻¹, but attenuation of the higher order modes by more than approximately 100 m⁻¹, and usefully over approximately 1000 m⁻¹ are contemplated. On the other hand, in an application where the highest frequency of operation is only a few GHz (or less) and the transmission length is tens of meters, the threshold of relative attenuation requires a TEM attenuation constant of approximately 0 m⁻¹ to approximately 0.01 m⁻¹, while attenuating the higher order modes by at least approximately 1.0 m⁻¹, but usefully by more than approximately 10 m⁻¹ are contemplated. It is emphasized that these examples are merely illustrative, and are not intended to be limiting of the present teachings.

As noted above, an “electrically thin” layer is one for which the layer thickness is less than the skin depth δ at the (highest) signal frequency of interest. This insures that the substantially TEM mode is minimally absorbed. The skin depth is given by δ=1/√(πfμσ), where δ is in meters, f is the frequency in Hz, μ is the magnetic permeability of the layer in Henrys/meter, and σ is the conductivity of the layer in Siemens/meter.

So for the discussion herein, if t is the physical thickness of the electrically thin resistive layer 1318, it is “electrically thin” if t<δₘᵢₙ=1/√(πfₘₐₓμσ), where δₘᵢₙ is the skin depth calculated at the maximum frequency fₘₐₓ. For example, suppose fₘₐₓ=200 GHz, the layer is nonmagnetic and hence μ=μ₀=the vacuum permeability=4π*10−7 Henrys/meter, and the conductivity is 100 Siemens/meter. Then δₘᵢₙ=112.5 μm, so a resistive layer thickness t of 25 μm would be considered electrically thin in this case. Recapitulating, the electrically thin resistive layer 1318 is electrically thin when its thickness is less than a skin depth at a maximum operating frequency of the electrical connector 1300.

Like embodiments described above, the dielectric region 1316 may comprise an inner dielectric material between the inner electrical conductor 1312 and the electrically thin resistive layer 1318, and an outer dielectric material between the electrically thin resistive layer 1318 and the outer electrical conductor 1314. In various embodiments, the inner dielectric material between the inner electrical conductor 1312 and the electrically thin resistive layer 1318, and the outer dielectric material between the electrically thin resistive layer 1318 have approximately the same thickness. In some embodiments, a thickness of the inner dielectric material is approximately twice a thickness of the outer dielectric material.

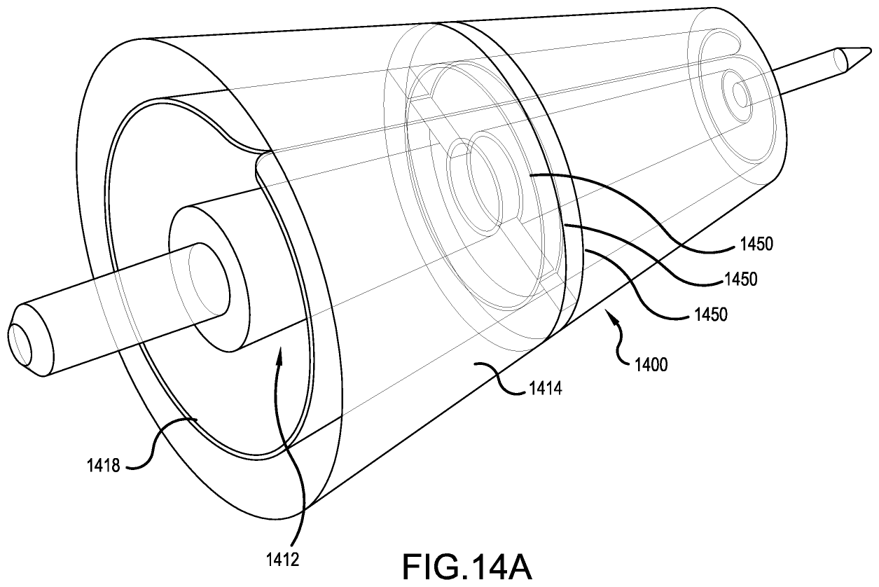

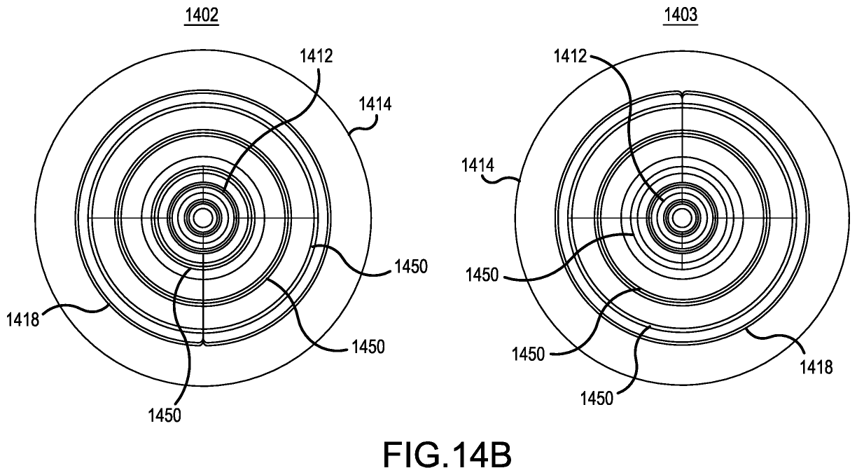

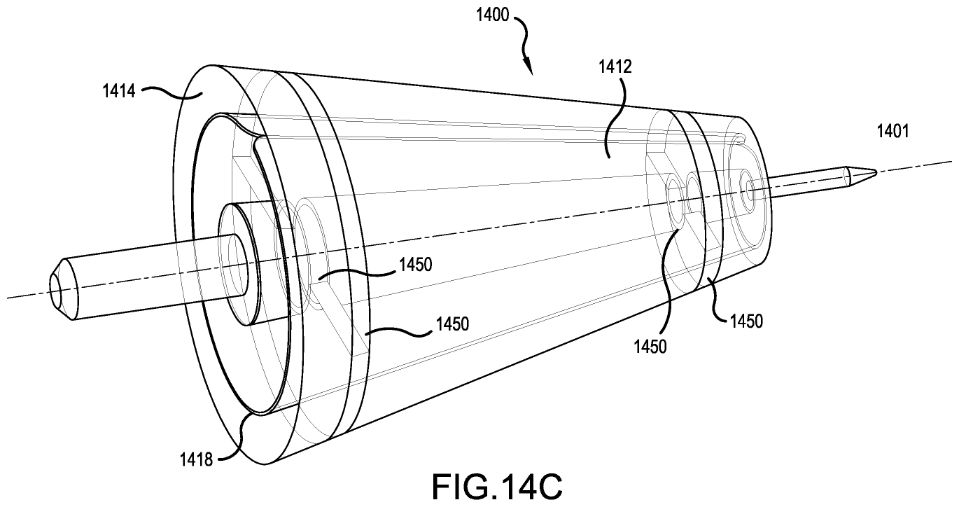

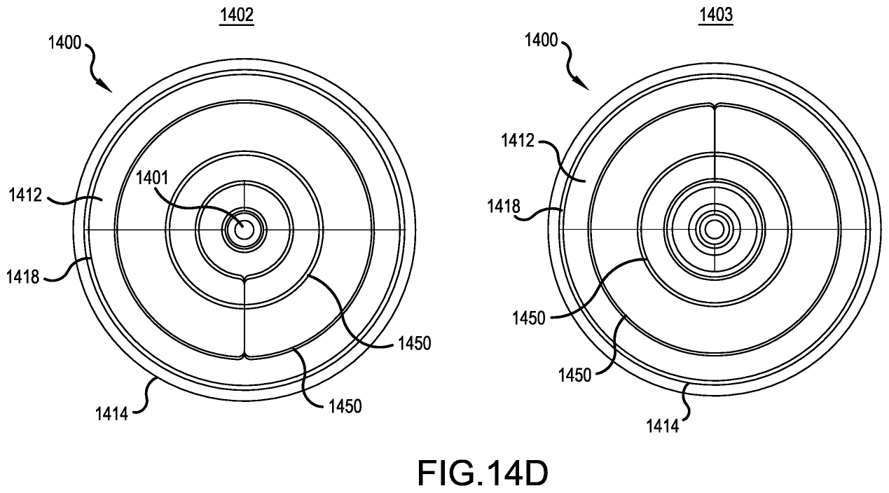

FIG. 14A is a perspective view of an electrical connector 1400 for coupling signal transmission lines in accordance with a representative embodiment. In FIG. 14A, a dielectric element 1450 is formed in a dielectric region. The dielectric element 1450 holds the inner electrical conductor 1412, and an electrically thin resistive sheet 1418.

The dielectric element 1450 may include a ring or rings as shown more clearly in FIGS. 14A,B. As will become clearer as the present description continues, the rings may form regions of reduced thickness of the dielectric regions. As can be appreciated, reduced the thickness of the dielectric element 1450 in the regions of the rings reduces the relative dielectric constant of the dielectric region between an inner electrical conductor 1412, and an outer conductor 1413. If the outermost ring of the dielectric element 1450 is considered as a boundary of such a region, then the region can be recognized to include a gas such as air everywhere except the volume occupied by the dielectric element 1450. As such, reducing the volume of the dielectric element 1450 by reducing the thickness of the dielectric element 1450 where the rings are disposed, reduces the overall dielectric constant of the dielectric region.

The dielectric element 1450 may be considered multiple dielectric elements 1450, and takes a form that includes one or more rings. A single dielectric element 1450 may be disposed between the inner electrical conductor 1412 and an outer electrical conductor 1414 approximately mid-length of the electrical connector 1400. Alternatively, and as shown in FIG. 14C, two dielectric elements 1450 may be provided, with one dielectric element 1450 disposed near the narrow end of the electrical connector 1400, and another dielectric element 1450 disposed near the wide end. Of course, more than two dielectric elements 1450 are contemplated with the understanding that for a given material, each dielectric element 1450 increases the overall dielectric constant of the dielectric region between the inner and outer electrical conductors 1412, 1414.

A center axis runs 1401 through the interior of the electrical connector 1400. The inner electrical conductor 1412, outer electrical conductor 1414, the dielectric element 1450 and/or at least the rings of the dielectric element 1450, are substantially azimuthally symmetric about the center axis 1401 in FIG. 14A. Additionally, the inner electrical conductor 1412, outer electrical conductor 1414, and at least the rings of the dielectric element 1450 are tapered along their respective lengths. That is, the inner electrical conductor 1412, outer electrical conductor 1414, and rings of the diametric element have smaller radiuses from the center axis to the right in FIG. 14A, and larger radiuses from the center axis to the left in FIG. 14A. As a result, each of the inner electrical conductor 1412, outer electrical conductor 1414 has a larger cross-sectional area at one end than at another end. The same is true of the dielectric element.

In FIG. 14A, the taper has a length sufficient to maintain a skew between the inner electrical conductor 1412 and the outer electrical conductor 1414 of less than approximately 25 electrical degrees at a highest operating frequency of the electrical conductors. Alternatively, the taper may have a length sufficient to maintain a skew between the inner electrical conductor 1412 and the outer electrical conductor 1414 of less than approximately 20 electrical degrees at a highest operating frequency of the electrical conductors. The skew (Δϕ) in degrees is approximated by Δϕ=360(f/v)[√(L²+(a₂−a₁)²)−√(L²+(b₂−b₁)²)], where f is the frequency in Hz, v is the phase velocity corresponding to the dielectric region, L is the axial length of the taper, a1 is an outer conductor radius of the first electrical conductor, b1 is an inner conductor radius of the first electrical conductor, a2 is an outer conductor radius of the second electrical conductor, and b2 is an inner conductor radius of the second electrical conductor.

Additionally, for shallow taper angles which may be useful for low skews, the skew length between the signal and ground paths can be approximated as (αₒ²−αᵢ²)L/2, where the outer and inner half-angles αₒ and αᵢ are measured in radians, not degrees. Using the fact that 20°=π/9 radians, a rule of thumb is

(√εᵣ)*L*fₘₐₓ*(αₒ²−αᵢ²)/c<1/9.

Here εᵣ is the relative dielectric constant in the taper, fₘₐₓ is the maximum desired operation frequency, and c is the speed of light in vacuum.

Due to the fact that αₒ and αᵢ are not independent, if 50 ohms is to be maintained throughout the taper, then the outer conductor/inner conductor radius ratio may be maintained at a₁/b₁=a₂/b₂=exp((5/6)*(√εᵣ)) where exp(x) is the exponential function e^{x}. Thus, the small half-angles also satisfy the following equation:

αₒ/α_{I}=exp((5/6)*(√εᵣ))

The above-noted equations may be used to fully describe constraints on the taper.

Additionally, a delay skew concern may be raised in a departure from a perfect cylindrical coaxial cable or connector. In such a departure, a length difference (and hence skew) will exist between the path that the signal/inner conductor takes and the path that the ground return/outer conductor takes. A commercial, stepped adapter can introduce such skew because the step discontinuity in the outer conductor is significantly larger than step discontinuity in the inner conductor due to the need to preserve diameter ratios in order to preserve characteristic impedance of the TEM mode. According to the present disclosure, using a tapered adapter, skew can be easily calculated from Pythagorean geometry. Referring to taper half-angles, e.g., for a conical taper, a planar CPW taper, or a coupled-line taper, αᵢₙₙₑᵣ and αₒᵤₜₑᵣ for the respective inner and outer conductors, path skew is given by

d_{L}=L*(sec(αₒᵤₜₑᵣ)−sec(αᵢₙₙₑᵣ))

where L is the axial length of the taper and sec is the secant function.

For shallow half-angles, path skew can be approximated as

d_{L}˜(L/2)*((αₒᵤₜₑᵣ)²−(αᵢₙₙₑᵣ)²)

where the half-angles are measured in radians, not degrees.

A rule of thumb is to keep the phase delay skew<20 degrees (=pi/9 radians) at the highest frequency of interest f_{_max}. This means that

2πi*fₘₐₓ*d_{L}*√(εᵣ)/c<π/9

Substituting the above estimate of d_{L},

L*f_{_max}*√(εᵣ)*((αₒᵤₜₑᵣ)²−(αᵢₙₙₑᵣ)²)/c<1/9.

Here εᵣ is the relative dielectric constant in the taper. In the case where air is the constant, εᵣ would be 1.0 and c is the speed of light in a vacuum.

The electrically thin resistive sheet 1418 is provided also between the inner electrical conductor 1412 and the outer electrical conductor 1414. The electrically thin resistive sheet 1418 may be provided along the entire lengths of the inner and outer electrical conductors 1412, 1414, or may be provided along a portion such as the portions where the inner and outer electrical conductors 1412, 1414 are wider to the left in FIG. 14A. For example, the electrically thin resistive sheet 1418 may be disposed along the entire length of a taper, and less than the entire length of the electrical connector 1400. Indeed, the electrically thin resistive sheet 1418 may not be particularly required or beneficial for a narrower portion of an electrical connector 1400, such as when the narrower portion of an electrical connector 1400 does not propagate higher order modes that would be attenuated. In another example, a second electrically thin resistive layer (not shown in FIG. 14A or 14B) may be also disposed between the inner and outer electrical conductors 1412, 1414.

As explained elsewhere in this disclosure, the electrically thin resistive sheet 1418 may serve the function of being substantially transparent (e.g., passing) a substantially transverse-electromagnetic (TEM) mode of transmission, while substantially attenuating entirely higher order modes of transmission. In an embodiment, the electrically thin resistive sheet 1418 may be disposed in the dielectric region, and between the inner electrical conductor 1412 and outer electrical conductor 1414.

The dielectric element 1450 can be split into, e.g., four pieces. The four pieces can include two inner pieces between a center conductor and a electrically thin resistive sheet 1418, and two outer pieces between the electrically thin resistive sheet 1418 and an outer conductor. The inner pieces can be easily assembled first, and the outer pieces can be easily assembled around the inner pieces. Alternatively, the dielectric element 1450 can be split into two pieces, i.e., an inner piece, and an outer piece. The two pieces can be assembled by sliding the inner piece into place (from a narrower end) of the electrical connector, and then sliding the outer piece into place (from the narrower end).

As shown in FIG. 14A, the electrically thin resistive sheet 1418 has curved corners and a slight gap between the ends of the sheet. As shown, the sheet has a seam indicating where the sheet begins and ends, and the curved corners appear at the seam on both ends of the electrical connector. The curved corners and gap will not cause a significant problem in attenuating higher order modes as explained herein.

FIG. 14B includes cross-sectional views of the electrical connector for coupling signal transmission lines of FIG. 14A. In FIG. 14A and FIG. 14B, the inner electrical conductor 1412 and outer electrical conductor 1414, and dielectric element 1450, are substantially azimuthally around center axis 1401. As described more fully below, this azimuthal symmetry substantially prevents mode conversion of a transverse electromagnetic (TEM) mode to either a higher-order transverse electric (TE) mode, or a higher order transverse magnetic (TM) mode.

In the two cross-sectional views of FIG. 14B, the front view of the 1402 left is the comparatively narrower end afforded by the tapering of elements, and the rear view 1403 on the right is the comparatively wider end due to the tapering of elements. As shown, three rings of dielectric element 1450 appear in each view, as well as the inner electrical conductor 1412 and outer electrical conductor 1414.

FIG. 14C is a perspective view of another electrical connector for coupling signal transmission lines in accordance with a representative embodiment. In FIG. 14C, two unconnected dielectric elements 1450 each hold a center conductor and a electrically thin resistive sheet 1418. The dielectric element 1450(s) each form a ring in the manner shown. In FIG. 14C, the front view 1402 is at the narrower tapered end of the electrical connector, and the rear view 1403 is at the wider tapered end of the electrical connector.

Similar to the dielectric element 1450 shown in FIG. 14A, the dielectric elements 1450 shown in 14C can include multiple pieces (e.g., two or four) that can be assembled piece by piece. Alternatively, dielectric elements 1450 in FIG. 14C can be slid into place on the electrical connector from the narrower end, with the larger dielectric element 1450 on the left being slid on before the smaller dielectric element 1450 on the right.

As shown in FIG. 14C, the electrically thin resistive sheet 1418 has curved corners and a slight gap between the ends of the sheet. As shown, the sheet has a seam indicating where the sheet begins and ends, and the curved corners appear at the seam on both ends of the electrical connector. The curved corners and gap will not cause a significant problem in attenuating higher order modes as explained herein.

FIG. 14D includes cross-sectional views of the electrical connector for coupling signal transmission lines of FIG. 14C. In FIG. 14D, the cross-sectional view is similar to the cross-sectional view of FIG. 14B, but only two rings of a dielectric element 1450 are present.

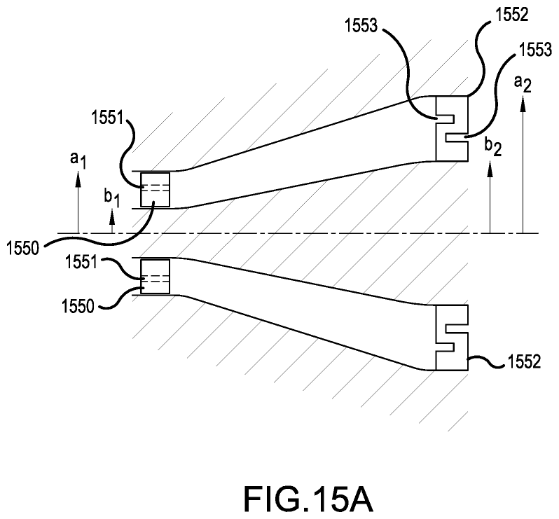

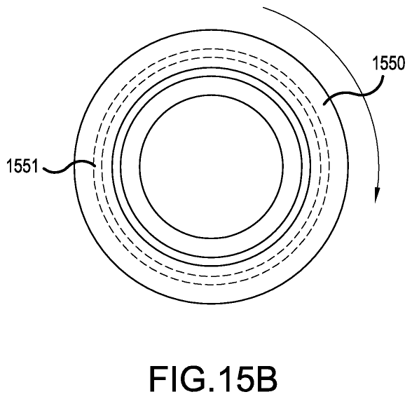

FIG. 15A illustrates azimuthal symmetry for electrical connectors in accordance with a representative embodiment. Azimuthal symmetry is a rotational symmetry around the center axis of a structure. In FIG. 15A, b1 and b2 are two points forming a straight line on the structure shown. Additionally, a1 and a2 are also two points forming a straight line on the structure shown. Given the azimuthal symmetry, a1 and a2 are rotated by the identical amount (in degrees) from the axis shown. Similarly, b1 and b2 are rotated by the identical amount (in degrees) from the axis shown.

In FIG. 15A, a smaller dielectric element 1550 comprises rings 1551, and is disposed at the narrower end of the smaller dielectric ring of dielectric element 1550 is shown; and a larger dielectric element 1552 with rings 1553 is shown. These rings are areas of reduced thickness of the dielectric element 1550, and are provided in an azimuthally symmetric manner ensure that dielectric rings are symmetric about the axis shown.

FIG. 15B includes cross sectional views of the electrical connector of shown in FIG. 15A, and depicts the rings of the smaller dielectric element 1550 and rings 1551.

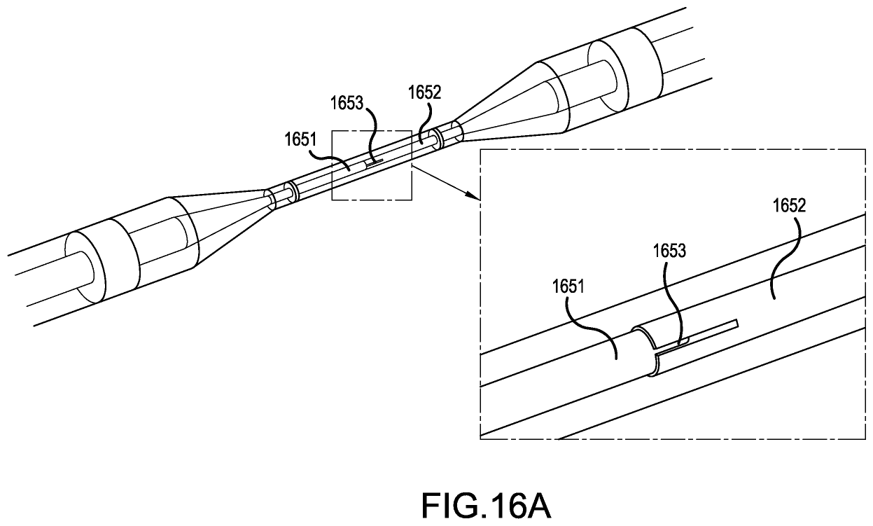

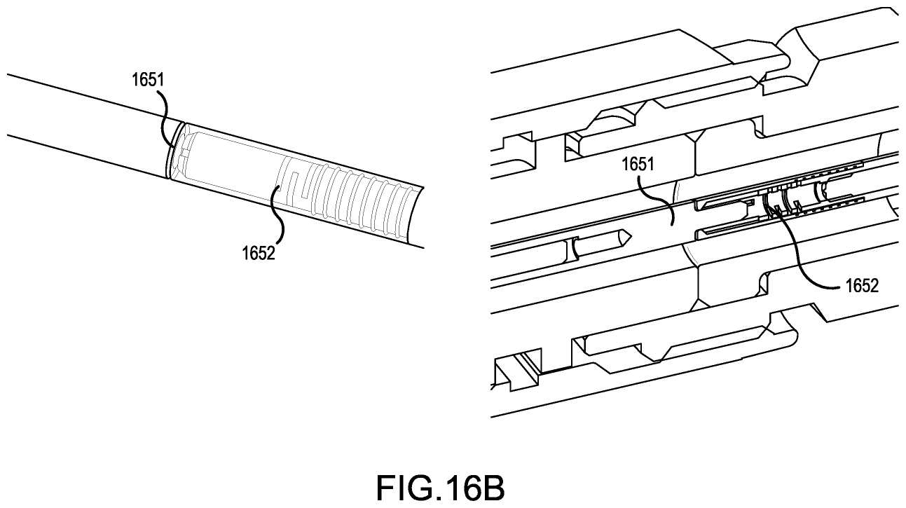

FIG. 16A is a perspective view of a slotted electrical connector for coupling signal transmission lines in accordance with a representative embodiment. In FIG. 16A, a male portion of the slotted electrical connector is inserted into a female portion of the slotted electrical connector. In FIG. 16A, the male portion of the slotted electrical connector can be inserted into the female portion such that the two portions are locked together.

FIG. 16B is a perspective view of a slotless electrical connector for coupling signal transmission lines in accordance with a representative embodiment. In FIG. 16B, the male portion of the slotless electrical connector can be inserted into the female portion without locking the two portions together using slots.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

According to an aspect of the present disclosure, an electrical connector is configured to electrically couple a signal transmission line to another signal transmission line. The electrical connector includes a first electrical conductor disposed around a center axis. The first electrical conductor has a taper along its length. The first electrical conductor is substantially azimuthally symmetric around the center axis. A second electrical conductor is disposed around the center axis. The second electrical conductor has the taper along its length. The second electrical conductor is substantially azimuthally symmetric around the center axis. A dielectric region includes a gas, and is disposed between the first electrical conductor and the second electrical conductor. The dielectric region has the taper along its length. A dielectric element is disposed in the dielectric region between the first and second electrical conductors. The dielectric element 1450 is substantially azimuthally symmetric around the center axis.

According to another aspect of the present disclosure, the dielectric element is a first dielectric element. The electrical connector includes a second dielectric element in the dielectric region between the first and second electrical conductors. The second dielectric element is substantially azimuthally symmetric around the center axis.

According to yet another aspect of the present disclosure, the electrical conductor includes an electrically thin resistive layer disposed between the first and second electrical conductors in at least a region along their respective lengths where the first and second electrical conductors have a greater width.

According to still another aspect of the present disclosure, rings exist in each of the first and second dielectric elements.

According to another aspect of the present disclosure, the rings are disposed substantially azimuthally symmetric around the center axis.

According to yet another aspect of the present disclosure, the rings include regions of reduced thickness of each of the first and second dielectric elements.

According to still another aspect of the present disclosure, the gas is air.

According to another aspect of the present disclosure, the substantially azimuthal symmetry of the first and second electrical conductors, and the substantially azimuthal symmetry of the first and second dielectric elements substantially prevent mode conversion of a transverse electromagnetic (TEM) mode to either a higher-order transverse electric (TE) mode, or a higher order transverse magnetic (TM) mode.

According to yet another aspect of the present disclosure, the first dielectric element occupies a first portion of the dielectric region, the second dielectric element occupies a second portion of the dielectric region, and the gas exists in a remaining portion of the dielectric region.

According to still another aspect of the present disclosure, the first dielectric element occupies a first portion of the dielectric region, the second dielectric element occupies a second portion of the dielectric region, and the air exists in a remaining portion of the dielectric region.

According to another aspect of the present disclosure, the taper has a length sufficient to maintain a skew between the first electrical conductor and the second electrical conductor less than approximately 25 electrical degrees at a highest operating frequency of the electrical conductor.

According to yet another aspect of the present disclosure, the taper has a length sufficient to maintain a skew between the first electrical conductor and the second electrical conductor less than approximately 20 electrical degrees at a highest operating frequency of the electrical conductor.

According to still another aspect of the present disclosure, the skew (Δϕ) in degrees is approximated by: Δϕ=360(f/v)[√(L²+(a₂−a₁)²)−√(L²+(b₂−b₁)²)], where f is the frequency in

Hz, v is the phase velocity corresponding to the dielectric region, L is the axial length of the taper, a₁ is an outer conductor radius of the first electrical conductor, b₁ is an inner conductor radius of the first electrical conductor, a₂ is an outer conductor radius of the second electrical conductor, and b₂ is an inner conductor radius of the second electrical conductor.

According to another aspect of the present disclosure, the skew (Δϕ) in degrees is approximated by: Δϕ=360(f/v)[√(L²+(a₂−a₁)²)−√(L²+(b₂−b₁)²)], where f is the frequency in Hz, v is the phase velocity corresponding to the dielectric region, L is the axial length of the taper, a₁ is an outer conductor radius of the first electrical conductor, b₁ is an inner conductor radius of the first electrical conductor, a₂ is an outer conductor radius of the second electrical conductor, and b₂ is an inner conductor radius of the second electrical conductor.

According to yet another aspect of the present disclosure, the first and second electrical conductors have respective first ends opposing respective second ends, and the first ends have a larger areal dimension that the respective second ends, resulting in the taper between the first and second ends.

According to still another aspect of the present disclosure, the dielectric layer has a first end opposing a second end, and the first end has a larger areal dimension that the second end, resulting in the taper between the first and second ends.

According to another aspect of the present disclosure, the electrically thin resistive layer is disposed along the entire length of the taper.

According to yet another aspect of the present disclosure, the electrically thin resistive layer is a first thin resistive layer, and the electrical connector further includes a second electrically resistive layer disposed between the first and second electrical conductors.

According to still another aspect of the present disclosure, the electrically thin resistive layer is disposed in the dielectric region, and between the first electrical conductor and the second electrical conductor. The electrically thin resistive layer is substantially transparent to a substantially transverse-electromagnetic (TEM) mode of transmission while substantially completely attenuating higher order modes of transmission.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to an advantage.

While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

1. An electrical connector configured to electrically couple a signal transmission line to another signal transmission line, the electrical connector comprising:
a first electrical conductor disposed around a center axis, the first electrical conductor having a taper along its length, wherein the first electrical conductor is substantially azimuthally symmetric around the center axis;
a second electrical conductor disposed around the center axis, the second electrical conductor having the taper along its length, the second electrical conductor being substantially azimuthally symmetric around the center axis;
a dielectric region comprising a gas, and disposed between the first electrical conductor and the second electrical conductor, the dielectric region having the taper along its length; and
a dielectric element disposed in the dielectric region between the first and second electrical conductors, the dielectric element being substantially azimuthally symmetric around the center axis.

2. The electrical connector of claim 1, wherein the dielectric element is a first dielectric element, and the electrical connector comprises a second dielectric element in the dielectric region between the first and second electrical conductors, the second dielectric element being substantially azimuthally symmetric around the center axis.

3. The electrical connector of claim 1, further comprising an electrically thin resistive layer disposed between the first and second electrical conductors in at least a region along their respective lengths where the first and second electrical conductors have a greater width.

4. The electrical connector as claimed in claim 2, wherein rings exist in each of the first and second dielectric elements.

5. The electrical connector of claim 4, wherein the rings are disposed substantially azimuthally symmetric around the center axis.

6.-19. (canceled)

20. An electrical connector configured to electrically couple a signal transmission line to another signal transmission line, the electrical connector comprising:
a first electrical conductor;
a second electrical conductor; and
an electrically thin resistive layer disposed between the first and second electrical conductors.

21. The electrical connector of claim 20, further comprising a dielectric region between the first and second electrical conductors.

22. The electrical connector as claimed in claim 21, wherein the electrically thin resistive layer is disposed within the dielectric region and disposed between the first electrical conductor and the second electrical conductor, the electrically thin resistive layer being configured to be substantially transparent to a substantially transverse-electromagnetic (TEM) mode of transmission while substantially attenuating higher order modes of transmission.

23. The electrical connector of claim 22, wherein an electric field exists between the first electrical conductor and the second electrical conductor, the electric field having electric field lines that are perpendicular to the electrically thin resistive layer at each point of contact with the electrically thin resistive layer.

24. The electrical connector of claim 20, wherein the first electrical conductor is substantially surrounded by the second electrical conductor, and is substantially located at a geometric center of the second electrical conductor.

25. The electrical connector of claim 21, wherein the dielectric region comprises:
a first dielectric layer disposed between the first electrical conductor and the electrically thin resistive layer; and
a second dielectric layer between the electrically thin resistive layer and the second electrical conductor.

26. The electrical connector of claim 25, wherein the first dielectric layer and the second dielectric layer have approximately the same thickness.

27. The electrical connector of claim 25, wherein a thickness of the first dielectric layer is approximately twice a thickness of the second dielectric layer.

28. The electrical connector of claim 25, wherein the electrically thin resistive layer comprises an electrically thin resistive coating on the first dielectric layer.

29. The electrical connector of claim 20, wherein electrically thin resistive layer is not continuous.
